(19) United States
(12) Patent Application Publication
(10) Pub. No.: US 2014/0085660 A1
(43) Pub. Date: Mar. 27, 2014

(54) SYSTEM AND METHOD FOR MANAGING INFORMATION PROCESSING APPARATUS

(71) Applicants: Toshiba Tec Kabushiki Kaisha, Tokyo (JP); KABUSHIKI KAISHA TOSHIBA, Tokyo (JP)

(72) Inventors: Yoshikatsu KAMISUWA, Tokyo (JP); Masaki NARAHASHI, Tokyo (JP); Sou MIYAZAKI, Tokyo (JP); Reiji MURAKAMI, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/012,141

(22) Filed: Aug. 28, 2013

(30) Foreign Application Priority Data
Sep. 27, 2012 (JP) 2012-214242

(51) Int. Cl. G06K 15/02

(52) U.S. Cl. CPC G06K 15/1803
USPC 358/1.14

(57) ABSTRACT

A system for managing an information processing apparatus includes a processing unit configured to calculate a range of appropriate values of a processing parameter of the information processing apparatus based on a range of values of substantially the same processing parameter currently or previously set in one or more information processing apparatuses, a display unit configured to display the range of appropriate values, and an input unit with which one or more values of the processing parameter of the information processing apparatus can be input.

### CROSS-REFERENCE TO RELATED APPLICATION

This application is based upon and claims the benefit of priority from Japanese Patent Application No. 2012-214242, filed Sep. 27, 2012, the entire contents of which are incorporated herein by reference.

### FIELD

Embodiments described herein relate to a system and a method for managing an information processing apparatus.

### BACKGROUND

Conventionally, when a condition of an information processing apparatus, such as a digital compound machine, is changed according to a specific usage environment (region) or when a setting value is changed during an operation to recover from a failure, and the like, a service person inputs a code corresponding to the setting attribute and the setting value corresponding to the code.

Due to digitization, colorization, and multi-functionalization of the information processing apparatus, the number of codes for the setting and adjustment of the information processing apparatus ranges from hundreds to thousands. The service person cannot remember all the codes.

Therefore, a service person needs to carry out the adjustment after finding the code by referring to a manual every time the service person carries out the adjustment. However, the appropriate value for the setting value may not be shown in the manual, and the service person may input a wrong value, which is outside the normal range. In addition, because the number of codes is numerous, the service person may mistakenly input a wrong code or a setting value for the wrong code.

### BRIEF DESCRIPTION OF THE DRAWINGS

FIG. 1 illustrates a schematic configuration of a system for managing an information processing apparatus according to a first embodiment.

FIG. 2 illustrates a configuration of a digital compound machine of FIG. 1.

FIG. 3 is illustrates functional blocks of a control section in the digital compound machine of FIG. 1.

FIG. 4 illustrates functional blocks of a maintenance apparatus for carrying out maintenance of the digital compound machine of FIG. 1.

FIG. 5 illustrates functional blocks of a management apparatus in the system.

FIG. 6 illustrates an example of a display screen according to a maintenance method of the first embodiment.

FIG. 7 is illustrates an example of a statistical data list.

FIG. 8 is a flowchart illustrating an example of steps to the change of the grid bias of a charger.

FIG. 9 is a flowchart illustrating a subroutine of FIG. 8.

FIG. 10 is a flowchart illustrating steps conducted at a digital compound machine in a system according to a second embodiment.

FIG. 11 is a flowchart illustrating steps conducted at a management apparatus in the system according to the second embodiment.

FIG. 12 illustrates a list of a fault occurrence example.

FIG. 13 illustrates a screen display example to designate a setting code.

FIG. 14 illustrates a code screen display example that a setting change cannot be carried out.

### DETAILED DESCRIPTION

In accordance with an embodiment, a system for managing an information processing apparatus includes a processing unit configured to calculate a range of appropriate values of a processing parameter of the information processing apparatus based on a range of values of substantially the same processing parameter currently or previously set in one or more information processing apparatuses, a display unit configured to display the range of appropriate values, and an input unit with which one or more values of the processing parameter of the information processing apparatus can be input.

Hereinafter, embodiments are described in detail with reference to accompanying drawings.

### First Embodiment

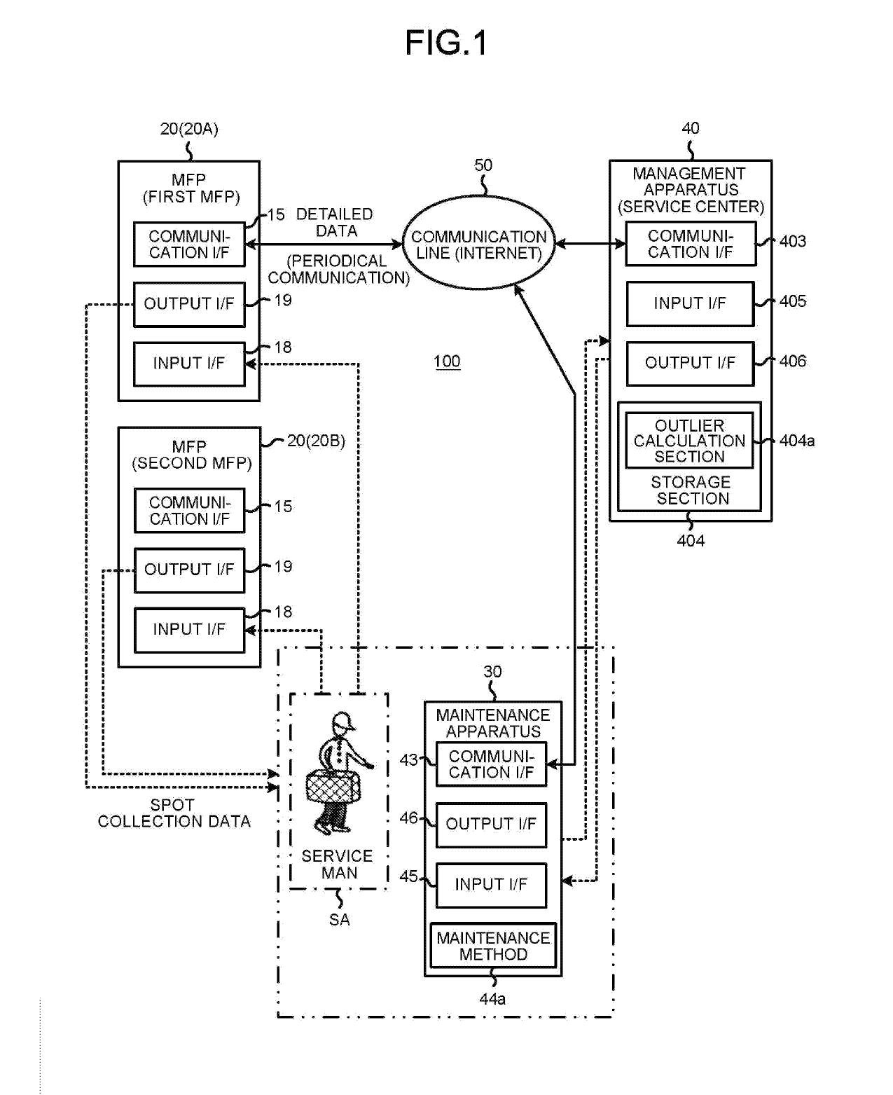

FIG. 1 illustrates a schematic configuration of a system for managing an information processing apparatus according to a first embodiment.

The maintenance apparatus 100 for the information processing apparatus shown in FIG. 1 comprises a digital compound machine 20, a maintenance apparatus 30 for the digital compound machine 20, and a management apparatus 40. The digital compound machine 20 of the embodiment is an MFP (Multi Function Peripheral) performing a plurality of information processing functions.

The digital compound machine 20 scans, reads, and copies an image with a designated resolution and a paper size, and in addition, the digital compound machine 20 performs functions of various office devices, such as an image reception function achieved by a FAX, an image reception function achieved by an electronic mail, a printed image reception function achieved by a network, and the like.

Alternatively, the digital compound machine 20, for example, may be a copier only having a copy function as long as it is a device carrying out an image processing. In addition, the digital compound machine 20 may be an apparatus having the single function of a scanner or a printer.

In order to carry out the maintenance of the digital compound machine 20, the maintenance apparatus 30 has a data communication function for sending and receiving maintenance data to and from the management apparatus 40 respectively.

Each digital compound machine 20 is used in various ways according to a utilization purpose, a setting environment, a setting condition, and the like. For example, data communication traffic may be limited or data communication function may be omitted or disabled.

In the maintenance apparatus 100 for the information processing apparatuses shown in FIG. 1, a digital compound machine 20 periodically sending detailed data to the management apparatus 40 is referred to as a first digital compound machine 20A, and a digital compound machine 20 which does not periodically send the data to the management apparatus 40 is referred to as a second digital compound machine 20B.

Each of the digital compound machines 20 comprises a communication interface 15, an input interface 18, and an output interface 19.

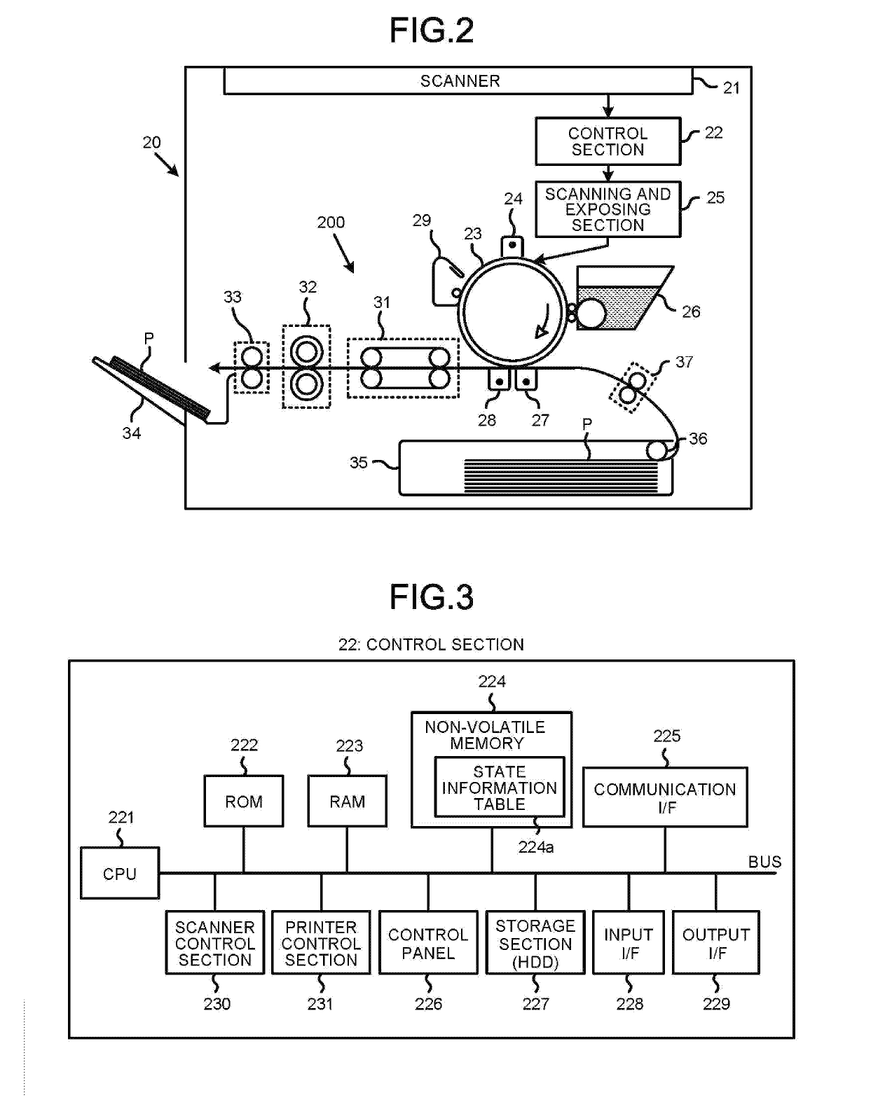

Configurations of the digital compound machine 20, i.e., an object to be managed, are further described in detail with reference to FIG. 2.

The digital compound machine 20 comprises a scanner 21, a control section 22, a photoconductive drum 23, a charger 24, a scanning and exposing section 25, a developer 26, a transferring charger 27, a peeling charger 28, a cleaner 29, a paper feed section 37, a paper conveying section 31, a fixer 32, a paper discharge section 33, and a paper discharge tray 34.

In addition, the photoconductive drum 23, the charger 24, the scanning and exposing section 25, the developer 26, the transferring charger 27, the peeling charger 28, the cleaner 29, the paper feed section 37, the paper conveying section 31, the fixer 32, the paper discharge section 33, and the paper discharge tray 34 constitute a printer 200.

The scanner 21 acquires image data by reading the image of an original in an optical manner. The scanner 21 outputs the acquired image data to the control section 22. The control section 22 controls each section. If the original is copied, the control section 22 forms (prints) the image of the original on paper P as an image-formed medium by controlling each section of the printer 200 according to the image data of the original acquired by the scanner 21.

The photoconductive drum 23 rotates in a vertical scanning direction (the circumferential direction of the photoconductive drum 23). The charger 24 is disposed near a periphery of the photoconductive drum 23. The charger 24 charges the surface of the photoconductive drum 23 uniformly. The scanning and exposing section 25 emits light/turns off a lamp according to an image signal while scanning a semiconductor laser. The semiconductor laser emitted from a semiconductor laser source constitutes a light scanned in a horizontal scanning direction (the rotation axial direction of the photoconductive drum 23) by a deflector such as a polygon mirror and the like. Afterwards, the semiconductor laser is irradiated on the photoconductive drum 23 by an optical system such as a lens and the like. When the semiconductor laser is irradiated on the charged photoconductive drum 23, the potential of an irradiated part is reduced to form an electrostatic latent image.

The developer 26 forms a toner image on the photoconductive drum 23 by coating a developing agent on the photoconductive drum 23. On the other hand, a paper tray 35 is arranged at the bottom of the digital compound machine 20. A paper feed roller 36 separates the paper P in the paper tray 35 one by one, and then, sends out the paper to the paper feed section 37. The paper feed section 37 feeds the paper P to the transfer position of the photoconductive drum 23. The transferring charger 27 transfers the toner image on the fed paper P. The peeling charger 28 peels the paper P from the photoconductive drum 23.

The paper P on which the toner image is transferred is conveyed by the paper conveying section 31. The fixer 32 fixes the toner image on the paper P. The paper discharge section 33 discharges the paper P on which the image is fixed to the paper discharge tray 34.

In addition, after the transfer of the toner image onto the paper P is ended, a residual toner on the photoconductive drum 23 is removed by the cleaner 29. The photoconductive drum 23 returns to an initial state to wait for the next image formation.

By repeating the operation above, an image forming operation is continuously carried out.

Next, configurations of a control system in the digital compound machine 20 are described with reference to a block diagram in FIG. 3.

The control section 22 comprises a CPU (processor) 221, a ROM 222, a RAM 223, a non-volatile memory 224, a communication interface (I/F) 225, a control panel 226, a storage section 227, an input interface (I/F) 228, an output interface (I/F) 229, a scanner control section 230, a printer control section 231, and the like.

The CPU (processor) 221 integrates and controls the overall operations of the digital compound machine 20. The CPU 221 executes various kinds of processing by executing a program stored in the ROM 222 or the non-volatile memory 224. The ROM 222 stores a control program, control data, and the like. The RAM 223 is utilized as a working memory or a buffer memory. The non-volatile memory 224 is a rewritable non-volatile memory. The non-volatile memory 224 stores the control program, the control data, and the like.

In addition, the non-volatile memory 224 comprises a state information table 224a storing a value denoting the usage state of the digital compound machine 20. The state information table 224a stores the data used as detailed data or simple data. For example, the state information table 224a stores a life counter value for determining a remaining life for each consumable. In addition, the state information table 224a also stores the value and the like detected by each sensor arranged in the digital compound machine 20.

In addition, the state information table 224a stores a total count value denoting a total number of printed sheets. The state information table 224a can also store a count value denoting a number of printed sheets with respect to each print mode (color, monochrome, and the like). In the state information table 224a, a number of printed sheets with respect to each paper size can be also stored. In addition, in the state information table 224a, the counter value denoting a number of times components other than the printer 200 are operated can be also stored. For example, the state information table 224a can store the count value denoting a number of times originals are read by the scanner 21.

The communication interface 225 is an interface for carrying out communication with an external apparatus (including the management apparatus 40). The communication interface 225 is the interface for carrying out the communication with the management apparatus 40 through a network.

The scanner control section 230 controls the scanner 21 according to an instruction from the CPU 221. The printer control section 231 controls the printer 200 according to the instruction from the CPU 221. The control panel 226 is a panel with which an operation instruction carried out by a user is input. The control panel 226 comprises a display section and an operation key. For example, the control panel 226 includes a touch panel display and a hard key.

The output interface 229 is an interface outputting a data (spot collection data) according to the operation of a service person. The spot collection data, for example, can be also a data equivalent to the detailed data periodically sent by the first digital compound machine 20A.

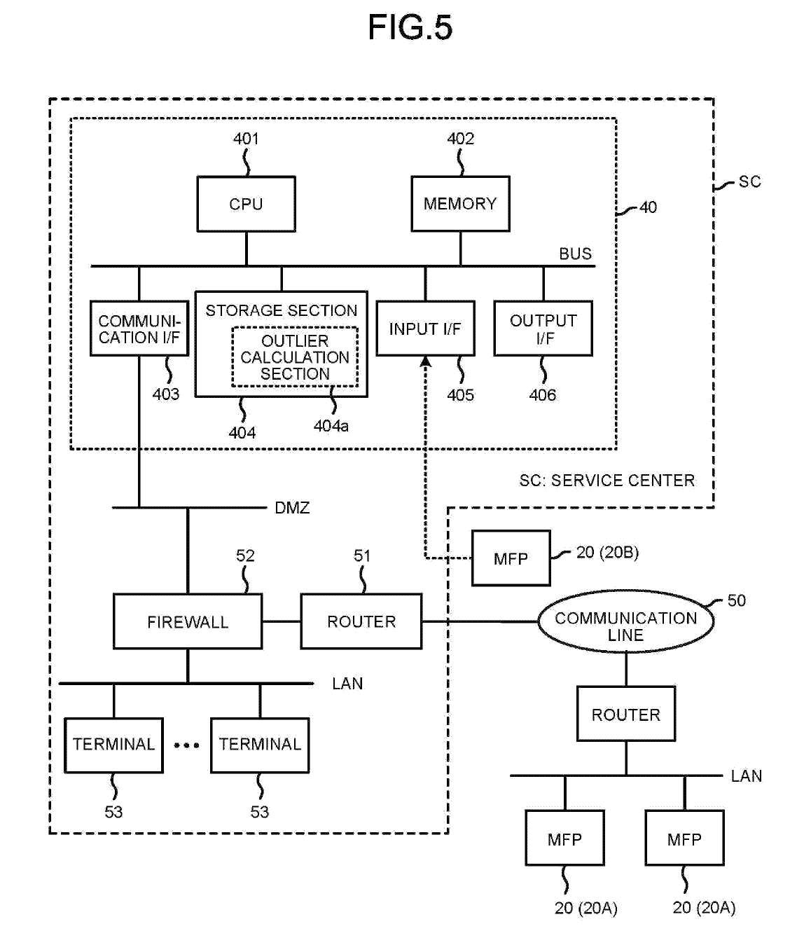

Any interface works as the output interface 229 so long as the interface can output the data which are conveyed to a service center by the service person SA and which can be input to the management apparatus 40 by the service person. For example, if an input interface 405 (FIG. 5) of the management apparatus 40 acquires the data from a memory card and the like connected locally, the output interface 229 can be also an interface which can output the spot collection data from the memory card and the like connected locally.

In addition, if the input interface 405 of the management apparatus 40 is an interface inputting the information key input by a keyboard and the like, the output interface 229 can be also an interface carrying out an output for printing the information denoting the spot collection data on the paper by the printer 200.

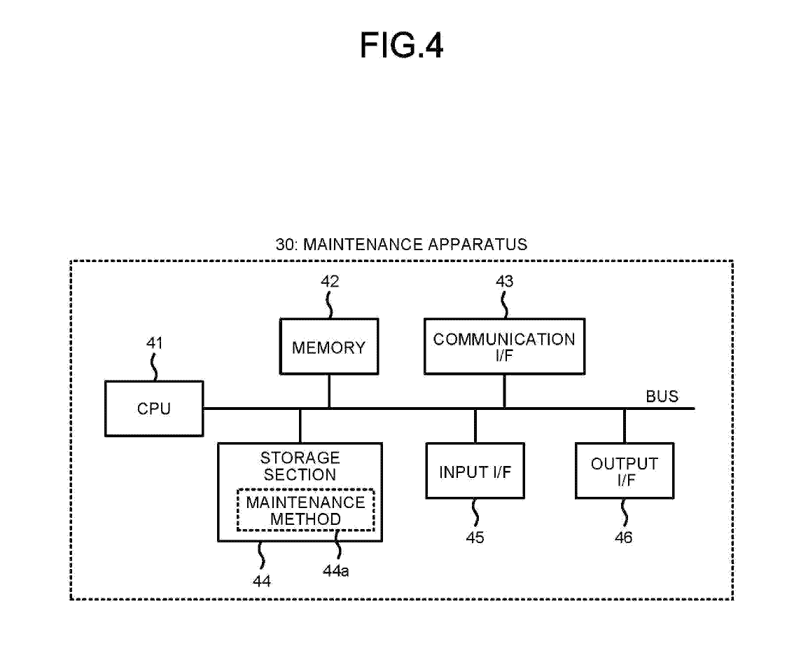

FIG. 4 illustrates functional blocks of a maintenance apparatus 30 for carrying out maintenance of the digital compound machine 20 of FIG. 1.

The maintenance apparatus 30 comprises a CPU 41, a memory 42, a communication interface 43, a storage section 44, an input interface 45, and an output interface 46. The communication interface 43 is an interface for sending and receiving the information between the management apparatuses 40 and the like through a communication line 50. A maintenance program 44a and the like are stored in the storage section 44. The input interface 45 is an input unit such as the keyboard to input the instruction or the data to the maintenance apparatus 30, a mouse, a USB interface, and the like. The output interface 46 is a display apparatus displaying the information. In addition, the input interface 45 and the output interface 46 can be also a common interface with which both the input and the output can be provided using a touch panel display with an input function and a display function.

FIG. 5 illustrates functional blocks of the maintenance apparatus in the overall system.

The system for managing the information processing apparatus carries out a maintenance service for each digital compound machine 20 with the service center SC in which the management apparatus 40 is located operating as a hub. A router 51 and a firewall 52 are disposed in the service center SC, so as to eliminate a wrongful access from an external apparatus. The management apparatus 40 is arranged in a demilitarized zone (DMZ) based on the firewall 52.

The management apparatus 40 includes a CPU 401, a memory 402, a communication interface 403, a storage section 404, the input interface 405, and an output interface 406.

The CPU 401 carries out an overall uniform control of the management apparatus 40. The memory 402 is equivalent to a main storage section of a personal computer. In addition, the CPU 401 has a function of performing the various kinds of processing by executing the program. The storage section 404 is a hard disk or an SSD (Solid State Drive), and a program, for example, stored in an outlier calculation section 404a of the storage section 404 executed by the CPU 401.

The communication interface 403 is an interface for sending and receiving the information to and from the digital compound machine 20 through the communication line 50. In addition, the communication interface 403 also functions as an interface carrying out the communication with a terminal 53 through the firewall 52 in the service center SC and a LAN.

The storage section 404 stores data and the like acquired from each digital compound machine 20 through the communication interface 403 or the input interface 405. The data acquired from each digital compound machine 20 are data related to a maintenance record, data related to a usage state, and the like.

The input interface 405 is the input unit such as the keyboard for inputting the instruction or the data of the management apparatus 40, the mouse, the USB interface, and the like. In addition, the input interface 405 can be also an interface from which the data from a storage medium such as the memory card connected locally or an external storage apparatus and the like is input.

The output interface 406 is an output unit achieved by the display configured to display the information. The output interface 406 can be also an interface outputting the data to the storage medium such as the memory card connected locally or an external storage apparatus and the like, can be also an interface outputting the data for printing the information on paper by the printer, and can be also an interface outputting data displayed on the display apparatus.

In addition, the digital compound machine 20B does not carry out the communication with the management apparatus 40 through a communication line 50, and the detailed data or the simple data are input to the management apparatus 40 by a person such as a service person and the like. The digital compound machine 20B does not (or need not) have a network connection with the external apparatus (including the management apparatus 40) using the communication line 50. Therefore, the hardware configuration of the second digital compound machine 20B may be the same as that of the first digital compound machine 20A except for the second digital compound machine 20B being not connected with the network.

In addition, the second digital compound machine 20B can also store the data equivalent to such detailed data as described above in the state information table 224a of the non-volatile memory 224. In such a condition, the second digital compound machine 20B outputs the data stored in the state information table 224a from the output interface 229 according to a direct operation carried out by the service person SA. Namely, the second digital compound machine 20B can output the spot collection data equivalent to the detailed data or the spot collection data equivalent to the simple data in a specific form according to the operation carried out by the service person SA. The data extracted from the second digital compound machine 20B by the operation of the service person SA are input to the management apparatus 40 by the operation carried out by the service person SA.

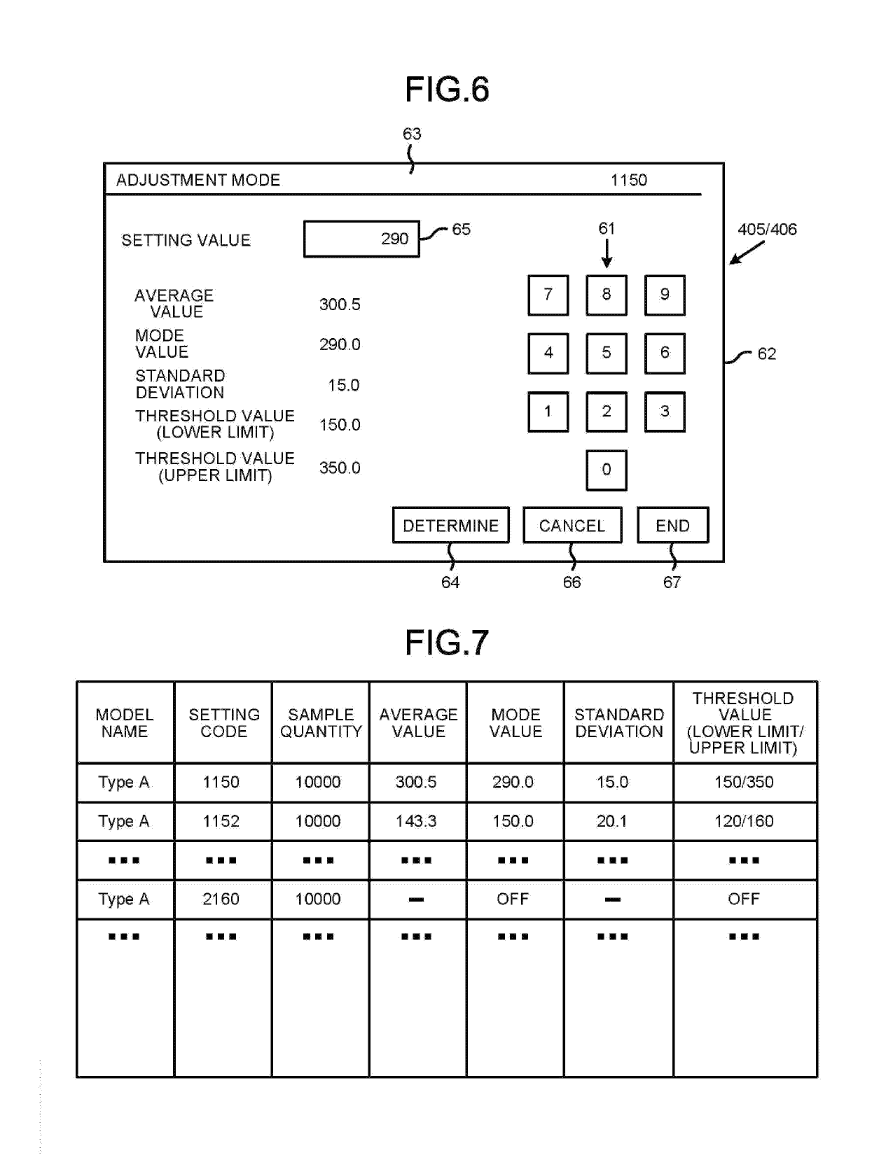

FIG. 6 illustrates an example of a display screen of the maintenance apparatus 30 that functions as the input interface 45 and the output interface 46 in an adjustment mode. In the example, the display is concurrently used as both the input interface 45 with a touch panel function capable of carrying out the input and the output interface 46.

Herein, an operation of adjustment in a condition that the setting code during the adjustment mode is set as [1150] is shown.

First, 1, 1, 5, and 0 as the setting codes in the adjustment mode are input from a numeric key 61. “1150” is displayed in an adjustment mode column 63 on a screen 62. Afterwards, a determination key 64 on the screen 62 is operated. Next, the value intended to be set, for example, 290, is input from the numeric key 61 in a setting value column 65. Afterwards, the determination key 64 is operated, so that the adjustment of an item corresponding to the setting code “1150” is ended.

If the image quality of an output image is abnormal or the image quality adjustment of the image is requested by a user, the service person changes each setting value of the digital compound machine 20 and carries out the image quality adjustment. For example, if a toner particle is attached to a non-image part and an image fuzziness is generated during development, and the problem is not solved even by the automatic adjustment, the setting value of the grid bias of the charger 24 is finely adjusted in a manual manner, so as to acquire a good image.

FIG. 7 illustrates a setting code example of the adjustment mode in a digital compound machine having a model name “Type A”. FIG. 7 illustrates an average value, a mode value, a standard deviation, and a threshold value (a lower limit/an upper limit) calculated by a sample quantity for different setting codes of the model. In addition, the “adjustment mode” denotes a state where the setting value (an adjustment value) can be changed (adjusted) in an application, and the code of the item serving as an adjustment object is used as the setting code.

The setting code “1150” in FIG. 7 is the grid bias, and the setting code “1152” is a fixing temperature. Though not shown in figures, the setting codes can be used for multiple coded adjustment items such as the rotation speed of a roller, a margin (blank) quantity and the like.

In addition, the setting code “2160” in FIG. 7 denotes that the function is not set. For example, the function equivalent to the setting code “2160” is processed as an option.

As described above, if the image quality of the output image is abnormal or the image adjustment on the image is requested by the user, the service person changes each setting value of the digital compound machine 20 and carries out the image quality adjustment. For example, if the toner particle is attached to the non-image part and an image fuzziness is generated during the development, and the problem is not solved even by the automatic adjustment, the setting value of the grid bias of the charger 24 is finely adjusted manually, so as to acquire a good image.

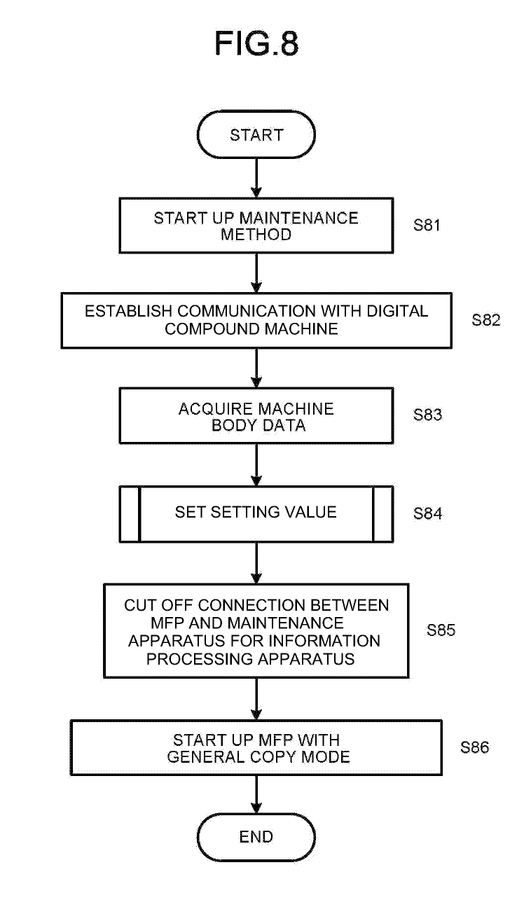

A flowchart in FIG. 8 describes an example of adjusting the grid bias of the charger 24 of the digital compound machine 20 to prevent the generation of the fuzziness.

When the service person starts up the maintenance apparatus 30, the CPU 41 starts up the maintenance program 44a (ACT S81).

Next, the CPU 41 establishes a communication between the communication interface 43 of the maintenance apparatus 30 and the digital compound machine 20 through a cable and the like (ACT S82). The CPU 41 acquires the machine body data of the digital compound machine 20, for example, the ID (identifier) of the digital compound machine 20 or a model name and the like (ACT S83). Once the CPU 41 acquires the machine body data of the digital compound machine 20, the processing of a setting value is carried out (ACT S84).

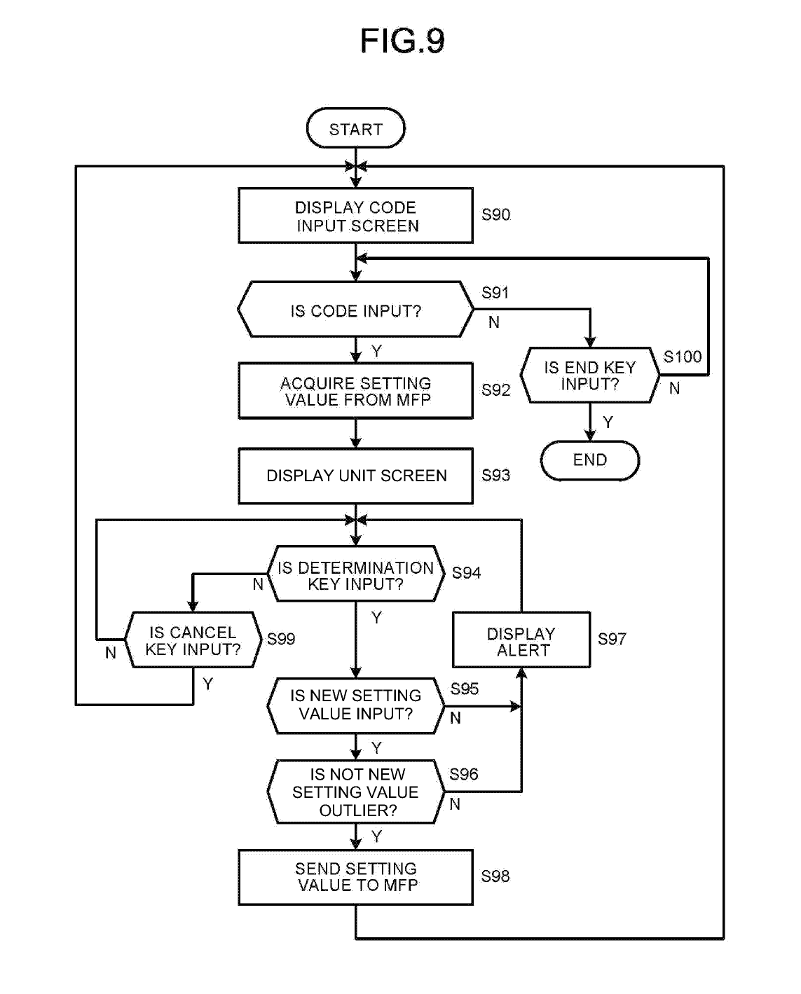

A flowchart in FIG. 9 illustrates the processing of a subroutine ACT S84 of FIG. 8.

To change the grid bias of the charger 24 of the digital compound machine 20, the CPU 41 first controls the maintenance apparatus 30 to display a display screen similar to the screen of the digital compound machine 20 in the adjustment mode and described in FIG. 6, based on the maintenance program 44a (ACT S90). According to the maintenance program 44a, the CPU 41 requests the service person to enter the code on the screen 62. The service person inputs the setting code “1150” corresponding to the grid bias on the screen 62 in response to the request.

The CPU 221 determines whether or not the setting code of the grid bias is input by referring to a code number correspondence table stored in the storage section 227 of the digital compound machine 20 (ACT S91). If the setting code of the grid bias is input, the CPU 221 acquires a currently-set value from the digital compound machine 20 (ACT S92), and sends the currently-set value of the grid bias to the maintenance apparatus 30.

If the storage section 44 acquires the currently-set value, the CPU 41 of the maintenance apparatus 30, causes the screen 62 to be displayed (ACT S93).

On the screen 62, a statistical data list of the setting value is displayed. The statistical data list of the setting value is previously calculated by an outlier calculation method (which is described below) and stored in a storage apparatus of the maintenance apparatus 30 in FIG. 7. For example, the average value, the mode value, the standard deviation, and the threshold value shown in FIG. 6 are displayed. By displaying statistical data such as the threshold value and the like on the setting value input screen, it can be determined whether or not the value that the service person intends to input is proper. If the service person intends to input a value as a setting value corresponding to a wrong code, as the threshold value is significantly different, the wrong input can be noticed quite easily.

In addition, FIG. 7 illustrates the structure of the statistical data list of the setting value, which includes the model name, the setting code, the sample quantity, the average value, the mode value, the standard deviation, and the threshold value. The sample quantity, listed as 10000, represents the number of the digital compound machines 20 that were used for calculating these statistical data.

The CPU 41 of the maintenance apparatus 30 determines whether or not the service person has input the setting value and whether or not the determination key 64 is operated (ACT S94). If the CPU 41 determines that the determination key 64 is operated, the flow proceeds to ACT S95 to determine whether or not the setting value has been input through the numeric key 61. If a new setting value is not input in ACT S95, and moreover, the setting value is determined to be an outlier in ACT S96, the CPU 41 displays an alert (ACT S97), and the flow returns to ACT S94.

If the CPU 41 determines that the setting value is not an outlier in ACT S96, the service person sends the code number and the setting value to the digital compound machine 20 based on the operation of the determination key 64 (ACT S98), and an initial screen is shown.

In ACT S94, if the service person inputs a wrong code or intends not to adjust the setting value, a cancel key 66 can be input (ACT S99) to return to the code input screen of ACT S90. In addition, in ACT S91, if an end key 67 is input on the code input screen (ACT S100), the setting operation of the setting value is ended.

Once the digital compound machine 20 receives the setting value, the currently-set value corresponding to the code number is updated with the setting value.

Afterwards, when the adjustment is ended in the routine shown in FIG. 9, the CPU 41 of the maintenance apparatus 30 cuts off the connection described above (ACT S85), and starts up the MFP in a general copy mode (ACT S86) in FIG. 8.

In addition, in ACT S94, the input of an outlier can be also prevented by using GUI (Graphical User Interface) parts such as a slider and the like instead of displaying an alert. In addition, a voice can be used to notify that the setting value is an outlier.

Next, an outlier calculation example of the setting value is described.

In order to determine an outlier of the setting value, first, an average setting value needs to be known. The average setting value is the value previously calculated as part of the statistical data by the outlier calculation unit 404a of the management apparatus 40 based on the machine body data of a market collected from the first digital compound machines 20A through the communication line 50 and the machine body data collected from the second digital compound machines 20B by the service person, and moreover, is periodically updated. The statistical data includes the average value, the standard deviation, and the sample quantity with respect to each setting code and with respect to each machine body category.

In addition, if the setting value is not a continuous value, for example, if an attribute is a nominal measure, as the average value cannot be calculated, the mode value is previously calculated instead. In addition, in order to determine whether or not the setting value is an outlier, the threshold value (the upper limit and the lower limit) preset for each setting code is needed. The threshold values are determined based on a setting range assumed when the image processing apparatus is designed, or determined based on values determined conventionally. The average value can be also a median value rather than an arithmetic average value depending on the property of setting items.

Next, a method for calculating the threshold value defining the outlier is described. Herein, two specific examples are described.

A calculation method in a first example is as follows. Thus, if the difference between the setting value and the average value is 3 times greater than the standard deviation, assuming that the statically acquired setting values have a normal distribution, the setting value is regarded as the outlier. If the setting value is set as x, the average is set as p, and the standard deviation is set as σ, the setting value meeting |x−μ|/σ>3 is regarded as the outlier.

This method is an ordinary method for detecting the outlier. Here, the upper limit of the threshold value is set as μ+3σ, and the lower limit of the threshold value is set as μ−3σ. It can also use the 2 times of the standard deviation rather than the 3 times of the standard deviation, and by this way more setting values can be extracted as outliers.

The calculation method in the second example is as follows. Thus, there is a suggested setting range determined at a design stage with respect to each setting item, and values outside the range can be regarded as an outlier. If the lower limit of the threshold value is set as θ₁ and the upper limit of the threshold value is set as θₕ, the setting value x meeting x<θ₁ and θₕ<x is regarded as the outlier.

Two outlier calculation methods are described above, but the outlier calculation method is not limited to these. For example, a method for calculating the threshold value of the outlier with a statistical manner such as the Smirnov•Grubbs detection can be also adopted.

The first digital compound machine 20A, for example, communicates with the management apparatus 40 in a periodic manner, e.g. 10 o'clock every day. The first digital compound machine 20A sends the data related to a current working state, such as the ID number of the first digital compound machine 20A, current date and time, the setting value, and the like, to the management apparatus 40 at the start of each period.

The management apparatus 40 stores the information received from the first digital compound machine 20A in the storage section 404. Subsequently, the first digital compound machine 20A ends the communication with the management apparatus 40. In the second digital compound machine 20B, when the service person visits a client, the data are acquired from the output interface 46 and the like of the maintenance apparatus 30 by using a removable medium such as a USB memory and the like, and the data are transferred to the management apparatus 40 by using the input interface 405 and the like.

Before the maintenance job of the first digital compound machine 20A is carried out, the service person uses the communication line 50 and the like to acquire the statistical data list of the setting value, as shown in FIG. 7, from the management apparatus 40, and stores the statistical data list in the storage apparatus of the maintenance apparatus 30. During the maintenance, the item of the display screen shown in FIG. 6 is displayed based on the statistical data list corresponding to the setting code of the item. The service person can carry out the adjustment according to the setting value displayed on the display screen. Therefore, the adjustment can be carried out based on the displayed setting values.

In the embodiment, the setting value of the digital compound machine is input in the state that the outlier information of the setting value is displayed on the setting value input screen. Thus, such a problem of setting the value outside the range of a normal action, or wrongly inputting the code number, or changing the expected code into other code can be prevented, so that the failure and the wrong action of a machine can be previously prevented.

### Second Embodiment

Next, a second embodiment of the maintenance apparatus for the information processing apparatus is described. In this embodiment, the wrong input of the code number can be prevented when the setting value of the digital compound machine is remotely input through the network.

For example, if a quality of the image output from the digital compound machine 20 is abnormal or the adjustment of the image quality is requested by the user, the service person changes each setting value of the digital compound machine 20 and carries out the adjustment of the image quality. If the fuzziness is generated in the image, and moreover, the problem is not solved even by the automatic adjustment, the setting value of the grid bias of the charger 24 of the digital compound machine 20 is finely adjusted manually, so as to acquire a good image.

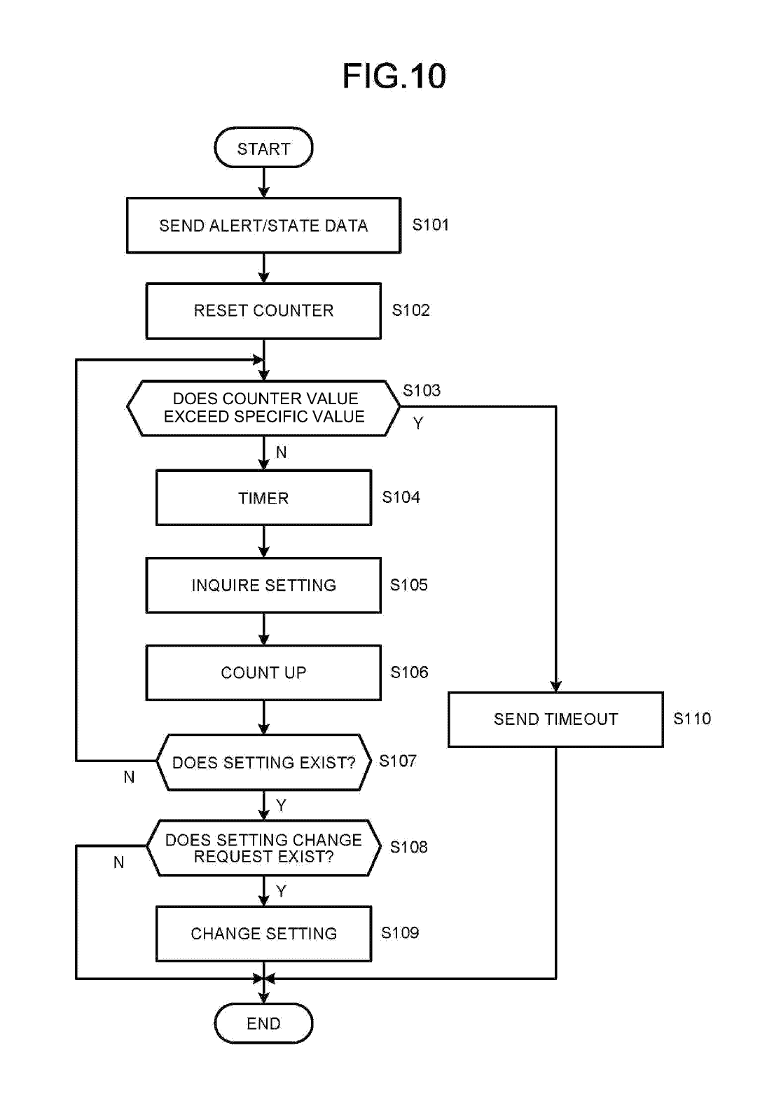

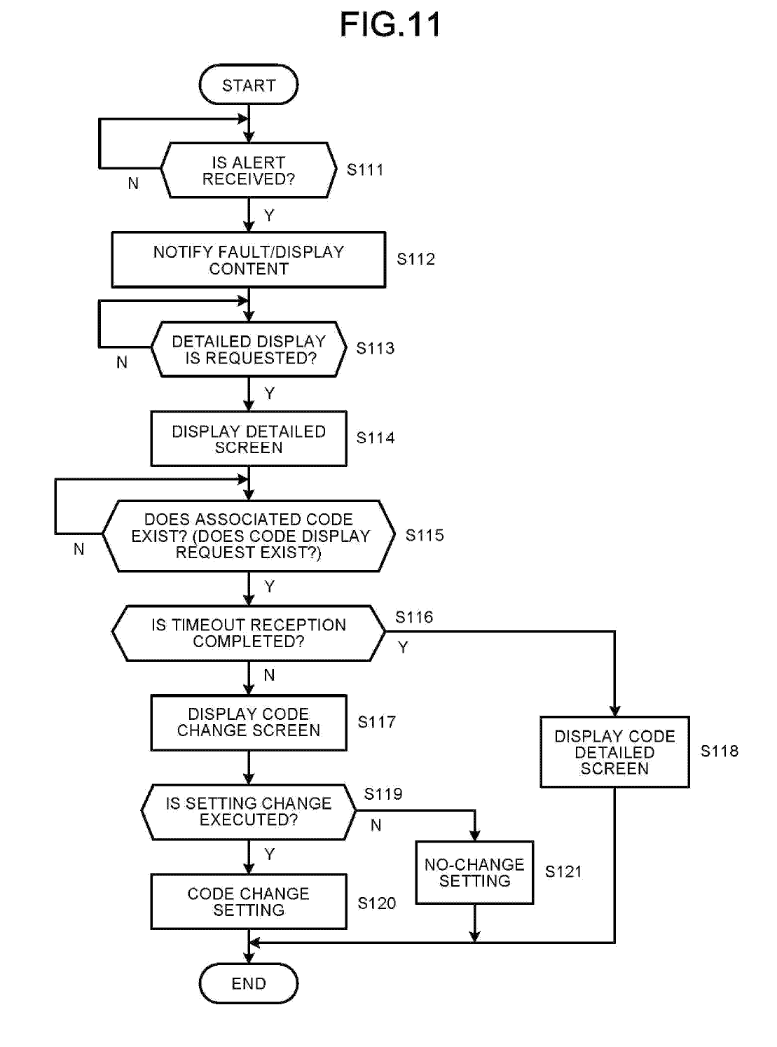

As an example, an operation of changing the grid bias value of the charger 24 to acquire a good image is described with reference to a flowchart of FIG. 10 illustrating an operation of the first digital compound machine 20A, a flowchart of FIG. 11 illustrating an operation of the management apparatus 40 in FIG. 11, and FIG. 1 to FIG. 5.

If the extent of the fuzziness occurring in the image reflected on the display screen of the first digital compound machine 20A is intense, and the abnormality is detected by an image density sensor which is not shown in the figures, the alert sending instruction is automatically carried out. In addition, if the telephone contact is carried out from the user, the user may carry out a specific operation from the control panel 226 of the first digital compound machine 20A to carry out the alert sending instruction manually. The CPU 221 sends the alert to the remote management apparatus 40, and simultaneously sends the data related to the state of the first digital compound machine 20A according to the alert sending instruction (ACT S101).

Thus, the CPU 221 turns into a state of waiting for an instruction from the management apparatus 40, and periodically carries out an inquiry. Namely, a counter for detecting a timeout is reset (ACT S102).

The CPU 221 determines whether or not the counter value exceeds a specific value (ACT S103), and proceeds to ACT 5104 if the counter value does not exceed the specific value.

In ACT 5104, the CPU 221 waits for a timer set, for example, 30 seconds, inquires the setting to the management apparatus (ACT S105), and counts up (ACT S106).

If the code change setting described below or the no-change setting is not carried out in the management apparatus 40, the CPU 221 returns to the count over determination in ACT 5103, and the inquiry is carried out repetitively until the counter value exceeds 60 times (30 minutes). In ACT 5103, if it is determined that the counter value exceeds the specific value, sends the result that the proceeding is timed out to the management apparatus 40 and terminates proceeding (ACT S110).

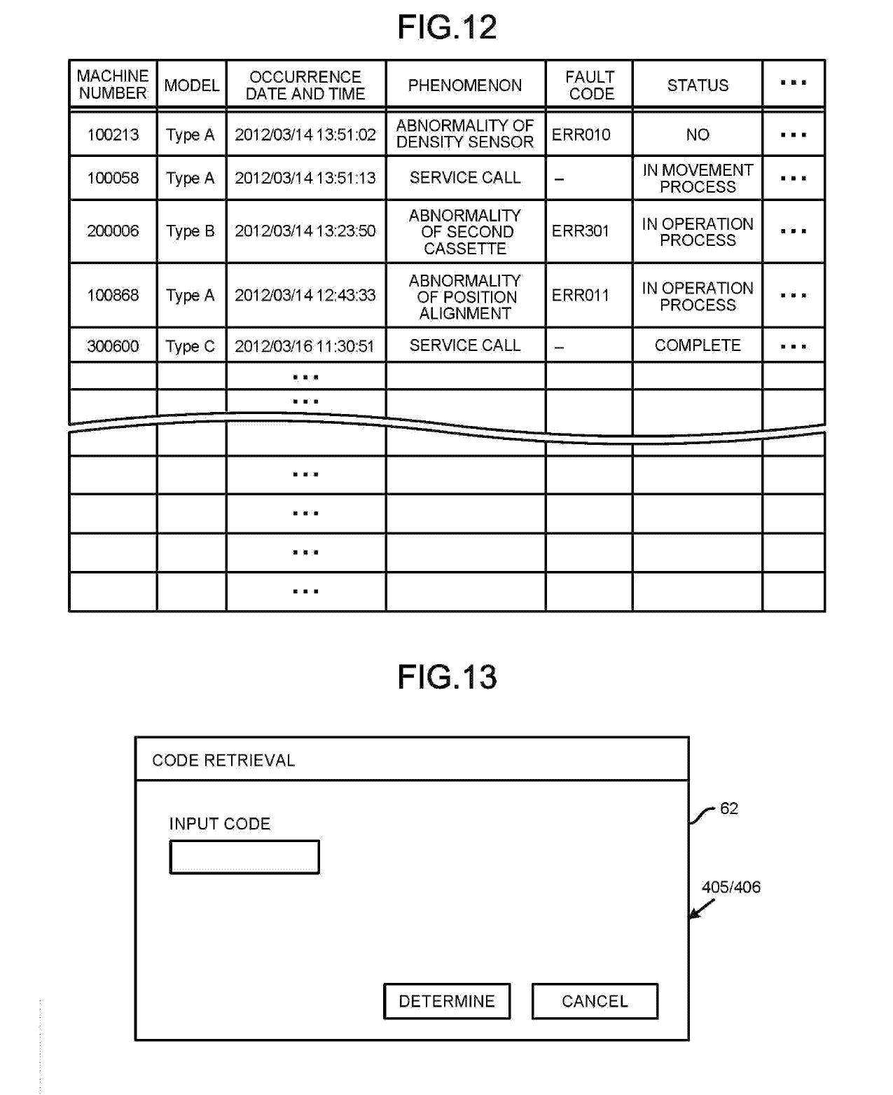

During the period, in the CPU 401 of the management apparatus 40, as shown in FIG. 11, whether or not the alert sent in ACT 5101 in FIG. 10 is received is determined (ACT 5111). If the alert is received, a fault content is displayed in the list of a fault occurrence example shown in FIG. 12, and is notified to an operator in the service center or the service person in charge (ACT S112).

Next, if the operator or the service person clicks a link in the fault and requests a detailed display (ACT S113), the CPU 401 displays a detailed screen (ACT S114).

If the setting code related to the state of the digital compound machine in association with the fault exists (ACT S115), the CPU 401 examines whether or not a timeout signal is received from the corresponding digital compound machine (ACT S116). If the timeout signal is not received in ACT 5116, a code change screen as shown in FIG. 6 is displayed (ACT S117). The code change screen is described below in detail.

In addition, in the request of the detailed display (ACT S113), there are cases when an associated code cannot be identified, such as when a failure is due to user's notification. In such a situation, a symptom can be estimated from a conversation and the like with the user, for example, by displaying the screen designated by the setting code as shown in FIG. 13 and accepting the input of the operator, the associated code is identified (ACT S115).

When the setting change is executed in the code change screen displayed in ACT 5117 (ACT S119), the CPU 401 sets the information of the setting code and the setting value as sent information sent to the first digital compound machine 20A (ACT S120), and operation ends.

If the cancel key 66 is operated in ACT 5119, and moreover, the setting change is canceled, the no-change setting is set as the sent information sent to the first digital compound machine 20A (ACT 5121) to end.

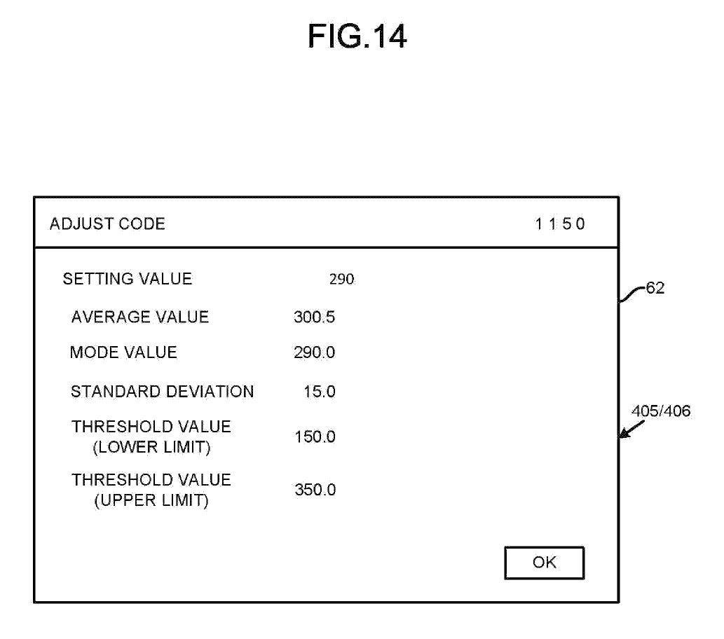

If the CPU 41 recognizes that the timeout reception is completed in ACT 5116, a code screen that the change setting cannot be carried out as shown in FIG. 14 is displayed (ACT S118), and operation ends.

On the other hand, the first digital compound machine 20A which is the state of waiting the instruction of the management apparatus 40 recognizes that setting information based on the code change setting (ACT 5120) or the no-change setting (ACT S121) exist in the management apparatus 40 during the inquiry of the setting (Yes in ACT S107), the flow proceeds to ACT S 108. If a setting change request is recognized (Yes in ACT S108), the setting change is carried out based on the information of the setting code and the setting value (ACT 5109), and if a no-change request is recognized (No in ACT S108), no action is not carried out, and operation ends.

Next, the code change screen is further described. If “1150” is set as the setting code corresponding to the grid bias of the charger 24, the code change screen is displayed with reference to the current value of the setting code of the first digital compound machine 20A stored in the storage section 404 by the CPU 401 of the management apparatus 40.

On the code change screen, the average value, the mode value, the standard deviation, and the threshold value are displayed by referring to the statistical data list of the setting value previously calculated based on the outlier calculation method described above and stored in the storage section 404, as shown in FIG. 7.

By displaying the statistical data such as the threshold value and the like on the screen, it can be determined whether or not the value intended to be input by the operator or the service person is proper. Moreover, if a service person intends to input a value as a setting value corresponding to a wrong code, as the threshold value is significantly different, the wrong input can be noticed quite easily.

The service person changes the setting value by operating the numeric key 61 on the screen shown in FIG. 6. The setting code and the new setting value are sent to the storage section 404, so that it can be referenced by the first digital compound machine 20A. If the operator inputs the wrong code or intends not to change the value, the cancel key 66 rather than the determination key 64 is input, and thus, the process is ended without changing the value. Here, the information of the no-change setting is stored in the storage section 404, so that it can be referenced by the first digital compound machine 20A.

The management apparatus 40 stores the information received from the first digital compound machine 20A in the storage section 404. Then, the first digital compound machine 20A recognizes the status of the communication, and ends the communication with the management apparatus 40.

In the embodiment, when the setting value of the digital compound machine is remotely changed through the communication line, the outlier information on the setting value input screen is displayed. By displaying such information, setting the value outside the range of the normal values, wrongly inputting the code number, or changing the expected code into other code can be prevented, so that the failure and the wrong action of the machine can be prevented.

In each embodiment described above, the maintenance apparatus for the information processing apparatus can be integrated into the information processing apparatus, or the maintenance apparatus can be independent from the information processing apparatus.

In each embodiment described above the adjustment of the grid bias is described, but the present disclosure can be applied to the sheet conveyance speed adjustment, the print speed adjustment, and the like. In addition, the digital compound machine is described as an example of the information processing apparatus, but not limited to this machine. The information processing apparatus can be any device having a function of connecting with the communication line and necessitating the adjustment, including a POS (point-of-sale information terminal).

In the embodiment, an example in which the function implementing the embodiment is previously recorded inside the apparatus is described, but is not limited to that. The same function can be also downloaded to the apparatus from the network, and a unit storing the same function in the storage medium can be also installed in the apparatus. As a recording medium, so long as the recording medium can store the method such as a CD-ROM and the like, and furthermore, is readable to an apparatus, its form can be any form. In addition, the function realized by such previous installation or the downloading can be also achieved by cooperating with an OS (operating system) and the like inside the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A system for managing an information processing apparatus, the system comprising:
a processing unit configured to calculate a range of appropriate values of a processing parameter of the information processing apparatus based on a range of values of substantially the same processing parameter currently or previously set in one or more information processing apparatuses;
a display unit configured to display the range of appropriate values; and
an input unit with which one or more values of the processing parameter of the information processing apparatus can be input.

2. The system according to claim 1, wherein
the range of appropriate values are displayed when one or more values of the processing parameters of the information processing apparatus can be input with the input unit.

3. The system according to claim 1, wherein
the display unit is further configured to display an average value of the values of the processing parameter currently or previously set in one or more information processing apparatuses.

4. The system according to claim 1, wherein
the display unit is further configured to display a standard deviation value of the values of the processing parameter currently or previously set in one or more information processing apparatuses.

5. The system according to claim 1, wherein
the processing unit is included in a management apparatus connected through a network to the information processing apparatus to be managed and one or more information processing apparatuses, and
the values of the processing parameter set in one or more information processing apparatuses are acquired therefrom through the network.

6. The system according to claim 5, wherein
the input unit and the display unit are included in a maintenance apparatus connected through a network to the information processing apparatus to be managed and to the management apparatus, and
the maintenance apparatus is configured to be carried by a person who inputs the value of the processing parameter with the input unit.

7. The system according to claim 1, further comprising:
a storing section configured to store the values of the processing parameter currently or previously set in one or more information processing apparatuses.

8. The system according to claim 1, wherein
the display unit is configured to display a message conveying that the value of the processing parameter input with the input unit is not appropriate if the input value is outside the range of appropriate values.

9. A method for managing an information processing apparatus, the method comprising:
calculating a range of appropriate values of a processing parameter of the information processing apparatus based on a range of values of substantially the same processing parameter currently or previously set in one or more information processing apparatuses;
controlling a display device to display the range of appropriate values; and
controlling the information processing apparatus to set the value of the processing parameter based on an input value.

10. The method of claim 9, wherein
the range of appropriate values are displayed when one or more values of the processing parameters of the information processing apparatus are input.

11. The method of claim 9, further comprising:
controlling the display device to display an average value of the values of the processing parameter currently or previously set in one or more information processing apparatuses.

12. The method of claim 9, further comprising:
controlling the display device to display a standard deviation value of the values of the processing parameters currently or previously set in one or more information processing apparatuses.

13. The method of claim 9, wherein
the appropriate value range of a processing parameter is calculated in a calculation unit included in a management apparatus connected through a network to the information processing apparatus to be managed, and
the values of the processing parameter set in one or more similar information processing apparatuses are acquired therefrom through the network.

14. The method of claim 13, wherein
the input device and the display device are included in a maintenance apparatus connected through a network to the information processing apparatus to be managed and to the management apparatus, and
the maintenance apparatus is configured to be carried by the person who sets the value of the processing parameter with the input device.

15. The method of claim 9, further comprising:
storing the values of the processing parameter currently or previously set in one or more information processing apparatuses.

16. The method of claim 9, further comprising:
controlling the display device to display a message conveying that the value of the processing parameter input with the input device is not appropriate if the input value is outside the range of appropriate values.

17. A non-transitory computer readable medium comprising a program that is executable in a computer system to cause the computer system to perform a method for managing an information processing apparatus, the method including the steps of:
calculating a range of appropriate values of a processing parameter of the information processing apparatus based on a range of values of substantially the same processing parameter currently or previously set in one or more information processing apparatuses;
controlling an display device to display the range of appropriate values; and
controlling the information processing apparatus to set the value of the processing parameter based on an input value.

18. The non-transitory computer readable medium of claim 17, wherein
the range of appropriate values are displayed when one or more values of the processing parameters of the information processing apparatus are input.

19. The non-transitory computer readable medium of claim 17, the method further comprising:
controlling the display device to display an average value of the values of the processing parameter currently or previously set in one or more information processing apparatuses.

20. The non-transitory computer readable medium of claim 17, the method further comprising:
controlling the display device to display a standard deviation value of the values of the processing parameters currently or previously set in one or more information processing apparatuses.
